(19) United States
(12) Patent Application Publication
(10) Pub. No.: US 2024/0403703 A1
(43) Pub. Date: Dec. 5, 2024

(54) RELEVANCE IN A KNOWLEDGE GRAPH

(71) Applicant: Apple Inc., Cupertino, CA (US)

(72) Inventors: Akshay AGGARWAL, San Jose, CA (US); Fatih SUNOR, San Francisco, CA (US); João Pedro LACERDA, Santa Cruz, CA (US); Jeffrey A. POUND, Waterloo (CA); Chiraag SUMANTH, Sunnyvale, CA (US)

(21) Appl. No.: 18/379,136

(22) Filed: Oct. 11, 2023

Related U.S. Application Data
(60) Provisional application No. 63/470,957, filed on Jun. 4, 2023.

(51) Int. Cl. G06N 20/00

(52) U.S. Cl. CPC G06N 20/00

(57) ABSTRACT

Aspects of the subject technology provide a relevance prediction based on a database of entities and statistics of past interactions between the entities. A relevance of a target entity in the database given a context of entities in the database may be predicted by deriving a probability set of at least one conditional probability from the database for each of the context entities, and then applying a machine learning model to the probability set to produce the relevance of the target entity.

### CROSS-REFERENCE TO RELATED APPLICATION(S)

The present application claims the benefit of U.S. Provisional Application No. 63/470,957, entitled “RELEVANCE IN A KNOWLEDGE GRAPH,” filed Jun. 4, 2023, the disclosure of which is hereby incorporated herein in its entirety.

### TECHNICAL FIELD

The present description relates generally to techniques for predicted relevance.

### BACKGROUND

Ambiguities in common human interactions may often be resolved based on knowledge of a context of the interaction. For example, a request to “call John” may seem ambiguous as to which of several possible names that include John are included in a phone book.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example context for a relevance query according to aspects of the subject technology.

FIG. 2 illustrates an example system for predicting relevance according to aspects of the subject technology.

FIG. 3 illustrates an example process flow from interaction statistics to relevance prediction according to aspects of the subject technology.

FIG. 4 illustrates an example process for predicting relevance according to aspects of the subject technology.

FIG. 5 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Techniques for improved predictions of relevance include predicting a relevance of an entity given a context for the relevance, where the prediction is based on statistics of past interactions with the entity. In an aspect, a relevance prediction may be based on a database of entities and statistics of past interactions between the entities. A relevance of a target entity in the database given a context of entities in the database may be predicted by collecting a probability set of at least one conditional probability from the database for each of the context entities, and then applying a machine learning model to the probability set to produce the relevance of the target entity. In an aspect, relevance prediction may be adaptable, for example based on new interaction statistics, and may be adaptable to entities the machine learning model was not initially trained for.

In an aspect, a database of entities and interaction statistics may be, for example, a personal knowledge graph for a user (or for a device associated with a user). The personal knowledge graph may include entities of various types (e.g., people, geographic locations, times, applications installed on a device) that are related to the user represented by the knowledge graph, and the personal knowledge graph may also include and/or may indicate measured statistics of interactions between entities in the database. The improved techniques may include determining a relevance of a target entity in the personal knowledge graph given a context of other entities in the personal knowledge graph by collecting a probability set of at least one conditional probability from the database for each of the context entities, and then applying a machine learning model to the probability set.

In an aspect, a relevance prediction may be produced in response to a relevance query, where the query specifies a target entity or class of entities in a database, and the query specifies a context for the relevance query. The context for the relevance query may be specified in terms of entities in the database. For example, in order to determine the relevance of a person named John at 3-4 pm on a Tuesday, a relevance query may request the relevance of the person entity corresponding to John given a two-part context including a time entity for 3-4 pm and a time entity for Tuesdays. In response to a relevance query, conditional probabilities can be derived from interaction statistics, and a probability set can be collected for the target entity and one or more context entities specified in the relevance query. A machine learning model may be applied to the probability set to produce a predicted probability that the query's target entity is relevant given the query context.

An example personal knowledge graph for a user is a database including two classes of entities and related statistics. The two classes may include a person class of entities, where each person entity represents a person that the user interacts with, and a time class of entities, where each time entity represents a period of time, such as an hour of the day or day of the week, that the user may interact with the people represented by person entities in the graph. The knowledge graph may also include statistics of interactions between pairs of the entities, such as statistics indicating how frequently the user has interacted with a human corresponding to a person entity during a specific period of time corresponding to a time entity.

An example relevance query may request the relevance of John to a user between 3-4 pm on a Tuesday based on personal knowledge graph for the user that includes a person entity for John and time entities for 3-4 pm and Tuesday. A relevance prediction may be made from statistics of past interactions between the user and John stored as entity interaction statistics in the user's personal knowledge graph. Conditional probabilities may be derived from the statistics and collected into probability set. A machine learning model be applied to the probability set to predict a relevance of John to the user at 3-4 pm on a Tuesday.

In a first example application, relevance prediction may be used to resolve an ambiguity in a user command. The ambiguity in the command may correspond to a class of entities in a database. For example, in response to a user command to launch an application on a device, an ambiguity about which application may correspond to a class of application entities in a database. In another example, an ambiguous location in a user command may correspond to a class of location entities in the database. In response to identifying a user command ambiguity corresponding to class of entities in a database, a command processor may query a relevance prediction system for a prediction of relevance of an entity within the class of the ambiguity given a context in which the user command was issued. For example, a user command to “call John” may be ambiguous because the user has previously interacted with several people named John. By knowing a context of the request, such as knowing when the command was issued, and who is typically called at that time, the ambiguity may be resolved by identifying which John may be most relevant to the user who issued the command based on statistics of the user's prior calls to people named John. A command processor may identify the ambiguity as corresponding to a target class of entities in the database having a name attribute where the name includes “John.” The command processor may then query a relevance prediction system for a ranking of relevance within in the target class of entities. The query may include a context of the user command, such as a time and a location that the user issued the “call John” command. In response to the query, a relevance prediction system may provide a list of entities in the target class ranked by predicted relevance. For example, a list of people named John ranked by relevance to the user who issued the command given the context of time and location of the user when the command was given.

In an aspect, the command processor may then provide the ranked list or a subset thereof, such as the top three John entities ranked as most relevant to the user. Such a ranked list may allow the user to indicate which John was intended. In another aspect, the command processor may simply perform an action using the top ranked entity in the list. For example, in response to the “call John” user command, the command processor may initiate a phone call the person entity with highest predicated relevance to the user.

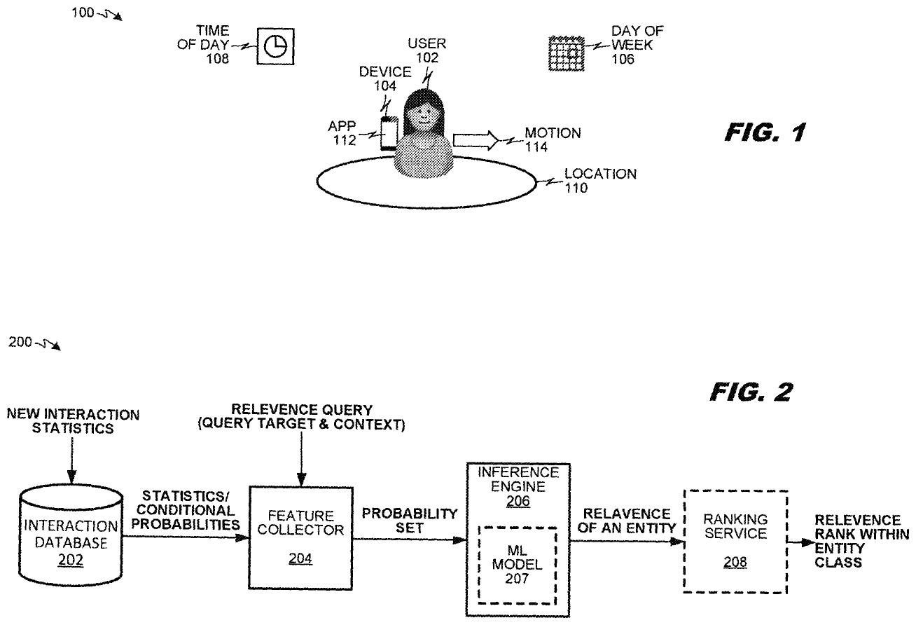

In a second example application of relevance prediction, a prediction of one or most relevant entities in a database may be provided for a specified context. For example, if a user of a device wishes to use one of many software applications (or “apps”) on the device, the device may provide a short list of applications ranked according to their predicted relevance to the user within a current context of the user. The current context may include, for example, the time (such as time of day and/or day of the week), location, and direction of motion of the user when the user indicates they may wish to use an unspecified app. Such a current context is illustrated in FIG. 1.

In another example, if a user wishes to indicate a location, such as a location for an event that the user is currently scheduling, a short list of locations ranked according to their predicted relevance to the user given the context of the event being scheduled. Such context could include the time of event or who the event is being scheduled with.

FIG. 1 illustrates example context 100 for a relevance query according to aspects of the subject technology. The example context 100 may be context for a user 102, or a context of a device 104 associated with user 102. Context elements for the example context 100 include a time of day 108 and day of week 106 that user 102 may be using device 104, location 110 of user 102 and/or device 104, and a direction of motion of user 102 and/or device 104. Such context elements may for a context for actions or commands performed on device 104 or performed for or by user 102. In an aspect, these context elements may be measured and recorded as statistics while user 102 uses device 104 and interacts with feature(s) or item(s) on the device (e.g., interacts with entities known to the device). For example, when an action is performed on device 102, such as launching a particular software application at a measured time of day 108 and location 110, the measured time of day, the time of day and location may be a context for the application launch action, and this interaction between the action, time of day, and location may be recorded as interaction statistics indicating relationships between the measured time of day and the action and the measured location and the action. In some implementations, the action and its context elements may each be separate entities in a database of interactions between the entities.

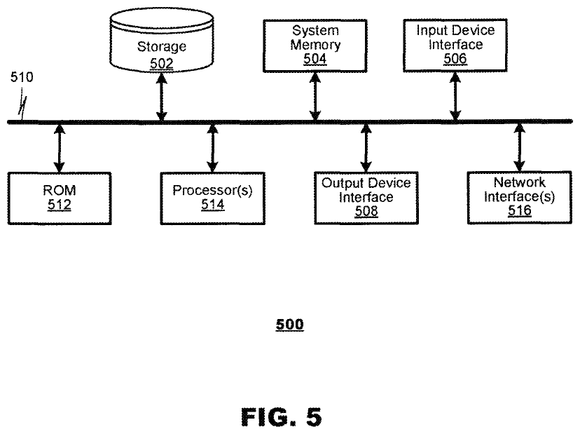

Other example context elements not depicted in FIG. 5 may include software components being executed on the device 104. Interactions between software components or applications on the device 104, networks the device 104 is connected to, and other user devices proximate to location 110 or being interacted with may also form context elements that are measured and recorded as interaction statistics for actions formed by device 104 or user 102. A state of device 104, including a state of software or hardware of device 104, such as Wi-Fi connection state, may also form context for actions.

In one or more implementations, the device 104 may be and/or may include all or part of the example computing device that is discussed further below with respect to FIG. 5.

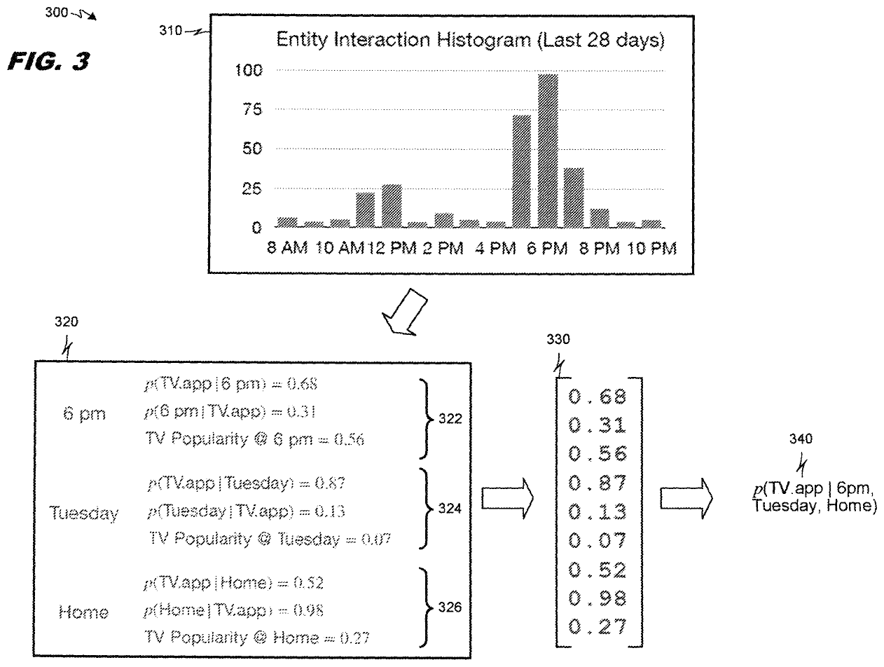

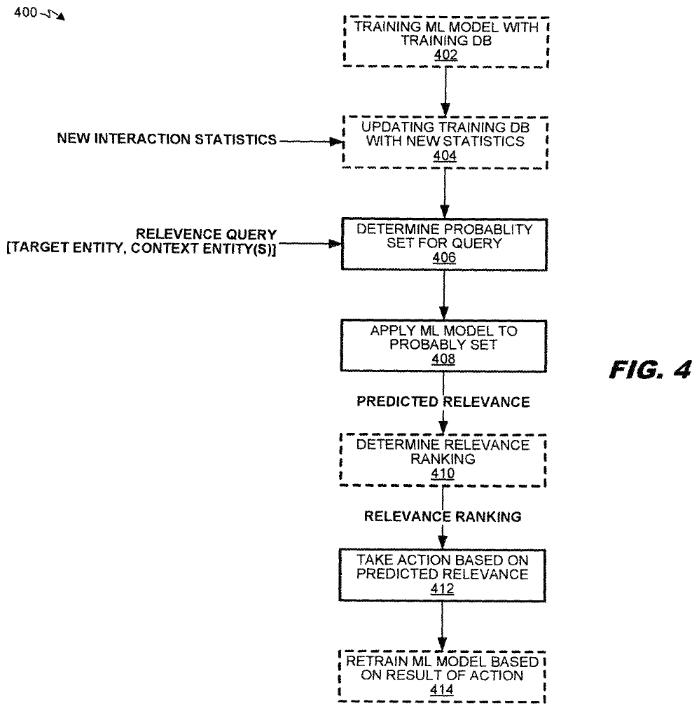

FIG. 2 illustrates an example system 200 for predicting relevance according to aspects of the subject technology. In one or more implementations, the system 200, and/or one or more components thereof, may be implemented by the device 104 of FIG. 1. System 200 includes an interaction database 202, feature collector 204, inference engine 206, and an optional ranking service 208. Interaction database 202 may include statistics of interactions between pairs of entities in the database. For example, interaction statistics may indicate a frequency a user performs an action, such as launching a TV app device 104, along with the context of that action, such as the time of day 108 and location 110 of the device 104 when the user launched the TV application. In response to a relevance query, feature collector 204 may collect conditional probabilities derived from interaction statistics in the database to form a probability set. An example probability set derived from interaction statistics is provided below regarding FIG. 3. Based on the collected probability set, inference engine 206 may predict a relevance of a target entity from the query given a context from the query. In an aspect, the inference engine 206 may apply a machine learning model 207 to the probability set in order to generate the predicted relevance.

In an aspect, a relevance query may specify a class of target entities in the interaction database 202, inference engine may predict a relevance for each entity in the class, and optional ranking service 208 may rank the entities in the class based on the predicted relevance for each entity. In some implementations, entities in the database have associated attributes. For example, for a person entity in the database may include a name attribute indicating a name of a person represented by that person entity in the database.

In an aspect, machine learning model 207 may accept a probably set of conditional probabilities for a target entity and may produce a prediction of relevance to a user of the target entity. For example, machine learning model 207 may be trained based on statistics of user 102's use of device 104. Collections of conditional probabilities derived from the statistics may be input to machine learning model 207, and the resulting relevance output may be compared to the actual device usage data of user.

FIG. 3 illustrates an example process flow 300 from interaction statistics to relevance prediction. Example interaction statistics, such as those stored in interaction database 202 (FIG. 2), are depicted in an example entity interaction histogram 310. Entity interaction histogram 310 may depict the number of times a user interacted with an entity (such as person or app on a device) within one-hour time periods of a day over some number of days. For example, histogram 310 may depict the number of times a user of a device launched an TV.app software application on the device over the last 28 days.

Interaction statistics, such as those depicted in histogram 310, of interactions between database entities that are collected and stored in the interaction database 202 may be used to derive conditional probabilities related to relevance of the entities. For example, given a relevance query for the relevance of the TV.app software application given a context of the 6 pm hour on a Tuesday at home, a plurality of conditional probabilities may be derived for each element of context. TV.app, the 6 pm hour, Tuesday, and home location may each be entities in the database. A list 320 of conditional probabilities may be derived from the statistics for pairs of the entities comprising the query target entity (TV.app) along with one of the query context entities (6 pm, Tuesday, home location).

For the 6 pm context entity, three different conditional probabilities are derived for the entity pair of (TV.app, 6 pm) and depicted as element 322. For the 6 pm context, this includes the 0.68 probability that the user launches the TV.app application on the device during the 6 pm hour of any day in the last 28 days; the 0.31 probability that it is during the 6 pm hour when TV.app is launched during the last 28 days; and 0.56 probability that if an app is launched during the 6 pm hour, the launched app will be TV.app. For the Tuesday context entity, three different conditional probabilities are derived for the entity pair of (TV.app, Tuesday) and depicted as element 324. This includes 0.87 probability of the target entity TV.app given the context of Tuesday; the 0.13 probability of the context entity Tuesday given the target entity TV.app, and the 0.07 popularity of the TV.app on Tuesdays. For the home location context entity, three different conditional probabilities are similarly derived for the entity pair of (TV.app, home location) and depicted as element 326.

Feature collector 204 may collect these conditional probabilities as a probability set 330, and inference engine 206 may infer a relevance prediction 340 from probability set 330. The relevance prediction in response to the query may be the probability that the TV.app application is relevant to the user during the 6 pm hour on a Tuesday at home.

In aspects of some implementations, a relevance prediction system, such as system 200 of FIG. 2, may be adaptable. In a first example, system 200 may adapt by adding new interaction statistics to interaction database 202. For example, device 104 may measure new interactions statistics for pre-existing entities in the interaction database, and add those new interaction statistics may be added to interaction database 202. The interaction database may be updated regularly to include interactions observed by the device 104 over a rolling fixed period of time, such as daily updates covering as rolling period of the past, e.g., 28 days. In an aspect of this example, inference engine 206 may include a machine learning model that was trained to predict relevance based on a training database of entities and statistics along with a metric for determining an accuracy of relevance predictions made by the machine learning model during training. Once training on the training database is complete, the interaction database 202 may be updated with new interaction statistics, and the machine learning model may be applied to the updated interaction database without (or prior to) additional training of the machine learning model.

In a second example of adaptation of a relevance prediction system, new entities may be added to interaction database 202. For example, a user may start interacting with a new coworker that may be added as a new person entity to interaction database 202, or a new software application may be installed on device 104 and may be added as new application entity to interaction database 202. Additionally, device 104 may collect statistics of interactions between the new entities and other entities in the database, and these interaction statistics for the new entities may be added to the interaction database 202. A relevance query referring to a new entity as target or context may cause inference engine 206 to predict relevance of a new entity and/or based on the context of a new entity, even if a machine learning model of inference engine 206 was not trained on an interaction database that included the new entities.

In a third example of adaptation of a relevance prediction system, inference engine 206 may be adapted to new interaction statistics, possibly including new database entities that were not previously known. For example, inference engine 206 may include a machine learning model that is trained (or retrained) based on an updated interaction database 202 with new interaction statistics and a metric for determining accuracy of the relevance predictions made by the machine learning model. For example, in response to a relevance query, user 102 may indicate the accuracy of the relevance prediction. In response to a user command with an ambiguity, the user may be presented with a list of entities ranked by predicted relevance in the context of the user command, and if the user selects the top ranked entity as the entity the user intended, the machine learning model may be reinforced as having made a correct prediction. Alternately, if the user were to select a lower-ranked entity as the intended entity, the machine learning model may be adjusted based on the correction from user.

FIG. 4 illustrates an example process 400 for predicting relevance according to aspects of the subject technology. For explanatory purposes, the process 400 is primarily described herein with reference to the device 104 of FIG. 1. However, the process 400 is not limited to the device 104 of FIG. 1, and one or more blocks (or operations) of the process 400 may be performed by one or more other components of other suitable devices. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

In one or more implementations, the process 400 may be performed by the device 104 and may include determining a probability set for a relevance query specifying at least one target entity in a database and at least one context entity in the database (406). A probability set may be determined, for example, by feature collector 204 from interaction database 202. A machine learning model, such as inference engine 206, may be applied to the probability set (408) to determine a predicted relevance of a target entity. An action may be taken based on the predicted relevance (412).

In an optional aspect of process 400, a ranking of predicted relevance may be determined (410) for plurality of target entities. For example, a relevance query may include a target class of entities, such as target class of application entities, class of all person entities, or a target class of the subset of person entities having an attribute that includes the name “John.” A probability set may be determined (406) for each entity in the query's target class. Then the machine learning model may be applied to the probability set for each entity in the target class, and a relevance ranking within the target entity class may be determined (410) by comparing the predicted relevance of the entities in the class. In an aspect, an action may be taken based on the ranking of relance, such as performing a user commend with the top ranked entity, or presenting a user with the list of top ranked entities in the class (such as in a user interface of a device).

In optional aspects of process 400 may enable relevance prediction to adapt to new interaction statistics. New interaction statistics may be added to an interaction database. For example, a machine learning model may be trained with a training database with a first set of entities and statistics (402) along with a metric for determining accuracy of the relevance predictions from the machine learning model. Then new interaction statistics may be added to the training database (404). A relevance query received after updating the training database may refer to new entities added with the new interaction statistics, and the previously trained machine learning model may be applied (408) to a probability set determined from new statistics in the updated database.

In another example, the machine learning model may be retrained on the new interaction statistics in the updated database. For example, an action taken based on the relevancy prediction from the updated database (412) may indicate the accuracy of the relevance prediction, for example by user selection from a ranked list of relevance. The indicated accuracy of relevance prediction from the machine learning model may be used to update weights in the machine learning model (414).

FIG. 5 illustrates an example computing device 500 with which aspects of the subject technology may be implemented in accordance with one or more implementations, including, for example system 200 (FIG. 2) and process 400 (FIG. 4). The computing device 500 can be, and/or can be a part of, any computing device or server for generating the features and processes described above, including but not limited to a laptop computer, a smartphone, a tablet device, a wearable device such as a goggles or glasses, an earbud or other audio device, a case for an audio device, and the like. The computing device 500 may include various types of computer readable media and interfaces for various other types of computer readable media. The computing device 500 includes a permanent storage device 502, a system memory 504 (and/or buffer), an input device interface 506, an output device interface 508, a bus 510, a ROM 512, one or more processing unit(s) 514, one or more network interface(s) 516, and/or subsets and variations thereof.

The bus 510 collectively represents all system, peripheral, and chipset buses that communicatively connect the numerous internal devices of the computing device 500. In one or more implementations, the bus 510 communicatively connects the one or more processing unit(s) 514 with the ROM 512, the system memory 504, and the permanent storage device 502. From these various memory units, the one or more processing unit(s) 514 retrieves instructions to execute and data to process in order to execute the processes of the subject disclosure. The one or more processing unit(s) 514 can be a single processor or a multi-core processor in different implementations.

The ROM 512 stores static data and instructions that are needed by the one or more processing unit(s) 514 and other modules of the computing device 500. The permanent storage device 502, on the other hand, may be a read-and-write memory device. The permanent storage device 502 may be a non-volatile memory unit that stores instructions and data even when the computing device 500 is off. In one or more implementations, a mass-storage device (such as a magnetic or optical disk and its corresponding disk drive) may be used as the permanent storage device 502.

In one or more implementations, a removable storage device (such as a flash drive) may be used as the permanent storage device 502. Like the permanent storage device 502, the system memory 504 may be a read-and-write memory device. However, unlike the permanent storage device 502, the system memory 504 may be a volatile read-and-write memory, such as random-access memory. The system memory 504 may store any of the instructions and data that one or more processing unit(s) 514 may need at runtime. In one or more implementations, the processes of the subject disclosure are stored in the system memory 504, the permanent storage device 502, and/or the ROM 512. From these various memory units, the one or more processing unit(s) 514 retrieves instructions to execute and data to process in order to execute the processes of one or more implementations.

The bus 510 also connects to the input and output device interfaces 506 and 508. The input device interface 506 enables a user to communicate information and select commands to the computing device 500. Input devices that may be used with the input device interface 506 may include, for example, alphanumeric keyboards and pointing devices (also called “cursor control devices”). The output device interface 508 may enable, for example, the display of images generated by computing device 500. Output devices that may be used with the output device interface 508 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 510 also couples the computing device 500 to one or more networks and/or to one or more network nodes through the one or more network interface(s) 516. In this manner, the computing device 500 can be a part of a network of computers (such as a LAN, a wide area network (“WAN”), or an Intranet, or a network of networks, such as the Internet. Any or all components of the computing device 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
in response to a relevance query including a target entity and query context comprising one or more context entities:
determining, from a database of entities including the target entity and the one or more context entities, a probability set for the target entity including one or more conditional probabilities for each of the one or more context entities, wherein the database includes statistics of interactions between pairs of entities in the relevance query;
applying a machine learning model to the probability set to determine a relevance of the target entity for the query context; and
taking an action based on the determined relevance.

2. The method of claim 1, wherein the machine learning model is trained with a training database, and the probability set is determined based on a current database, wherein the entities in training database and entities in the current database are different.

3. The method of claim 1, wherein the machine learning model is trained with a training database, and at least one of the target entity and the context entities are not in the training database.

4. The method of claim 1, wherein the machine learning model was trained with a training database, and the method further includes:
updating the training database with new statistics of interactions; and
wherein the probability set is determined from the updated training database.

5. The method of claim 1, wherein the one or more conditional probabilities for a first context entity includes at least a first conditional probability of the target entity given the first context entity and a second conditional probability of the first context entity given the target entity.

6. The method of claim 1, wherein the database is a personal knowledge graph of a user, and the target entity and the context entities are aspects of a device associated with the user.

7. The method of claim 6, wherein the aspects of the device include one or more of: a time period of a day the device is used, a day of a week the device is used, a location the device is used, an application used on the device, a motion of the device, or a Wi-Fi state of the device.

8. The method of claim 1, wherein the relevance query includes a target class of entities in the database, the target class of entities including the target entity, and the method further includes:
determining a relevance ranking amongst entities in the target class of entities in the database based on the determined relevance of the target entity; and
providing a response to the relevance query based on the determined relevance ranking.

9. The method of claim 8, wherein the method further includes at least one of: taking an action based on a most relevant entity in the relevance ranking; and presenting, in a user interface, a most relevant subset of entities in the relevance ranking.

10. The method of claim 8, wherein:
the target class of entities includes software application entities previously installed on a device;
the relevance query requests a ranking of predicted relevance amongst the target class; and
the action includes presenting, on a user interface of the device, one or more of the entities in the target class according to the relevance ranking.

11. The method of claim 8, wherein:
the target class of entities includes geographic location entities previously referenced by a user of a device;
the relevance query requests a ranking of predicted relevance amongst the target class; and
the action includes presenting, on a user interface of the device, one or more of the entities in the target class according to the relevance ranking.

12. The method of claim 8, wherein:
the target class of entities includes person entities previously referenced by a user of a device;
the relevance query requests a ranking of predicted relevance amongst the target class; and
the action includes presenting, on a user interface of the device, one or more of the entities in the target class according to the relevance ranking.

13. The method of claim 8, wherein:
entities in the database include attributes;
the relevance query includes a query attribute;
the target class of entities includes a subset of person entities having an attribute that matches the query attribute;
the relevance query requests a ranking of predicted relevance amongst the target class; and
the action includes presenting, on a user interface of the device, one or more of the entities in the target class according to the relevance ranking.

14. A system, comprising:
a processor; and
a memory storing instructions, that when executed by the processor, cause the system to:
in response to a relevance query including a target entity and query context comprising one or more context entities:
determine, from a database of entities including the target entity and the one or more context entities, a probability set for the target entity including one or more conditional probabilities for each of the one or more context entities, wherein the database includes statistics of interactions between pairs of entities in the relevance query;
apply a machine learning model to the probability set to determine a relevance of the target entity for the query context; and
take an action based on the determined relevance.

15. The system of claim 14, wherein the machine learning model is trained with a training database, and the probability set is determined based on a current database, wherein the entities in training database and entities in the current database are different.

16. The system of claim 14, wherein the machine learning model is trained with a training database, and at least one of the target entity and the context entities are not in the training database.

17. The system of claim 14, wherein the machine learning model was trained with a training database, and the instructions further cause the system to:
update the training database with new statistics of interactions;
wherein the probability set is determined from the updated training database.

18. The system of claim 14, wherein the one or more conditional probabilities for a first context entity includes at least a first conditional probability of the target entity given the first context entity and a second conditional probability of the first context entity given the target entity.

19. The system of claim 14, wherein the database is a personal knowledge graph of a user, and the target entity and the context entities are aspects of a device associated with the user.

20. A non-transitory computer readable memory storing instructions that, when executed by a processor, cause the processor to:
in response to a relevance query including a target entity and query context comprising one or more context entities:
determine, from a database of entities including the target entity and the one or more context entities, a probability set for the target entity including one or more conditional probabilities for each of the one or more context entities, wherein the database includes statistics of interactions between pairs of entities in the relevance query;
apply a machine learning model to the probability set to determine a relevance of the target entity for the query context; and
take an action based on the determined relevance.
